(19) United States
(12) Patent Application Publication
(10) Pub. No.: US 2013/0172055 A1
(43) Pub. Date: Jul. 4, 2013

(54) TERMINAL DEVICE

(71) Applicant: Ji Woong Han, Seoul (KR)

(72) Inventor: Ji Woong Han, Seoul (KR)

(21) Appl. No.: 13/823,643

(22) PCT Filed: Oct. 28, 2011
(86) PCT No.: PCT/KR2011/008148

§ 371 Date: Mar. 14, 2013

(30) Foreign Application Priority Data
Nov. 1, 2010 (KR) 10-2010-0107696

(51) Int. Cl. H04M 1/02

(52) U.S. Cl. CPC H04M 1/0266
USPC 455/566

(57) ABSTRACT

A terminal device for a cellular phone is provided. A video displayed in the terminal display unit of a portable terminal can be enlarged and displayed in the unit display unit of a display unit, and a variety of functions of the portable terminal can be used through the display unit.

### BACKGROUND OF THE INVENTION

1. Technical Field

The present invention relates to a terminal device and, more particularly, to a terminal device for performing a telephone call, Internet access, the play of a moving image and music, and/or various applications in the state in which a user carries the terminal device.

2. Description of the Related Art

In general, a terminal device is used to input or output data through a communication line. Recently, terminal devices for providing mobile communication service, such as mobile phones and a Personal Digital Assistant (PDA), are increasingly being used.

For example, a smart phone is a mobile phone for providing the same functions as a computer in addition to a voice call. That is, a smart phone can access the Internet by using wireless Internet, and a user can install various types of applications in the smart phone. The smart phone can also perform functions, such as e-mail and the play of a moving image. Accordingly, the smart phone is provided with a variety of interfaces for smooth and convenient manipulation and also equipped with a display unit for displaying various pieces of information and conditions in progress.

However, a terminal device, such as a smart phone, is inevitably formed in a small size in order to secure portability, and thus the display unit of the terminal device has a limited screen size. That is, in the terminal device, a variety of functions must be performed or manipulated through the display unit having a specific size or lower.

### SUMMARY OF THE INVENTION

An embodiment of the present invention provides a terminal device capable of improving a use environment of a user by expanding a screen, displayed in the terminal display unit of a portable terminal, to a wider screen.

Another embodiment of the present invention provides a terminal device capable of easily coupling a portable terminal with a display unit having a screen wider than that of the portable terminal.

In accordance with an embodiment of the present invention, a portable terminal configured to have at least one function of a telephone call, Internet access, the play of a moving image and music, or the execution of various applications and a display unit couled with the portable terminal and configured to have a unit display unit formed in the front of the display unit, the unit display unit having a larger screen than the terminal display unit, enlarging a video displayed in the terminal display unit of the portable terminal, and displaying the enlarged video. Furthermore, an attachment/detachment unit to or from which the portable terminal is slidably attached or detached is formed in portions other than the front of the display unit so that signals are transferred to the portable terminal.

That is, the display unit can be attached to or detached from the portable terminal very easily because the portable terminal is attached to or detached from the attachment/detachment unit of the display unit in a sliding coupling way. Furthermore, since a screen displayed in the terminal display unit is provided to a user as a more enlarged screen through the unit display unit, use convenience of the portable terminal can be improved depending on an environment in which the portable terminal is used.

The portable terminal may include a video output terminal for outputting the video displayed in the terminal display unit in a signal form. The attachment/detachment unit may include a video input terminal for displaying the video of the terminal display unit in the unit display unit in response to the video signal received from the video output terminal. The video input terminal and the video output terminal may be coupled together when the portable terminal is mounted on the attachment/detachment unit.

Accordingly, a video signal from the portable terminal can be transferred to the display unit through the video output terminal and the video input terminal. Furthermore, the display unit can display the same video as the terminal display unit in the unit display unit in response to a video signal.

A display unit power breaker for blocking a power source supplied to the terminal display unit when the portable terminal is mounted on the attachment/detachment unit can be formed in the contact portion of the attachment/detachment unit and the portable terminal. That is, when the portable terminal is mounted on the attachment/detachment unit, the display unit power breaker formed in the contact portion of the portable terminal and the attachment/detachment unit is driven, so power supplied to the terminal display unit can be blocked. Accordingly, when the portable terminal and the display unit are coupled together, unnecessary power consumption due to the portable terminal can be reduced.

The display unit may include a manipulation unit for receiving a command according to a manipulation of a user. The manipulation unit may include at least one of a touch screen, a touch pad, a key pad, an electronic pen, a Joystick, and a keyboard. That is, the display unit can control the operation of the portable terminal through the manipulation unit.

The display unit may include a signal output terminal for outputting the manipulation of the manipulation unit in a signal form. The portable terminal may include a signal input terminal for receiving the manipulation signal from the signal output terminal. The signal output terminal and the signal input terminal may be coupled together when the portable terminal is mounted on the attachment/detachment unit.

Accordingly, a manipulation signal from the display unit can be transferred to the portable terminal through the signal output terminal and the signal input terminal. Furthermore, the operation of the portable terminal can be controlled in response to the manipulation signal.

The display unit may include a power supply system for supplying a power source for an operation of the display unit. The portable terminal may be charged with the power source of the power supply system when the portable terminal is mounted on the attachment/detachment unit.

In accordance with another embodiment of the present invention, a terminal device includes a portable terminal configured to have at least one function of a telephone call, Internet access, the play of a moving image and music, or the execution of various applications, a display unit couled with the portable terminal and configured to have a unit display unit formed in the front of the display unit, the unit display unit having a larger screen than the terminal display unit, enlarging a video displayed in the terminal display unit of the portable terminal, and displaying the enlarged video, and a terminal docking unit configured to have one side rotatably coupled with an attachment/detachment unit formed in the rear of the display unit, have an insertion unit into which one side part of the portable terminal is inserted formed on the other side of the terminal docking unit, and relay signals between the portable terminal and the display unit. Furthermore, the terminal docking unit is selectively disposed at a first position where the portable terminal is inserted into the inside of the attachment/detachment unitor or a second position where the portable terminal becomes apart from the display unit at a specific angle so that the portable terminal and the terminal docking unit function as a support of the display unit.

That is, the display unit can be attached to or detached from the portable terminal very easily because the portable terminal is attached to or detached from the insertion unit of the terminal docking unit in a sliding coupling way. Furthermore, since a screen displayed in the terminal display unit is provided to a user as a more enlarged screen through the unit display unit, use convenience of the portable terminal can be improved depending on an environment in which the portable terminal is used.

Both side parts of the terminal docking unit may be rotatably hinged to both side parts of the attachment/detachment unit. The insertion unit may be formed in a groove shape in the terminal docking unit so that one side part of the portable terminal is slidably inserted into the insertion unit. That is, the terminal docking unit can be rotated around a hinge connection unit, and the portable terminal can be rotated along with the terminal docking unit in the state in which the portable terminal has been fit into the insertion unit.

The portable terminal may include a video output terminal for outputting the video displayed in the terminal display unit in a signal form. The terminal docking unit may include a video input terminal for displaying the video of the terminal display unit in the unit display unit in response to the video signal received from the video output terminal. The video input terminal and the video output terminal may be coupled together when the portable terminal is mounted on the terminal docking unit.

Accordingly, a video signal from the portable terminal can be inputted to the terminal docking unit through the video output terminal and the video input terminal and then transferred from the terminal docking unit to the display unit. Furthermore, the display unit can display the same video as the terminal display unit in the unit display unit in response to the video signal.

A display unit power breaker for blocking a power source supplied to the terminal display unit when the portable terminal is mounted on the terminal docking unit may be formed in the contact portion of the terminal docking unit and the portable terminal. That is, when one side part of the portable terminal is inserted into the insertion unit, the display unit power breaker formed in the contact portion of the one side part of the portable terminal and the insertion unit is driven, thereby being capable of blocking power supplied to the terminal display unit. Accordingly, when the portable terminal and the display unit are coupled together, unnecessary power consumption due to the portable terminal can be reduced.

The display unit may include a manipulation unit for receiving a command according to a manipulation of a user. The manipulation unit may include at least one of a touch screen, a touch pad, a key pad, an electronic pen, a Joystick, and a keyboard.

The terminal docking unit may include a signal output terminal for outputting the manipulation of the manipulation unit in a signal form. The portable terminal may include a signal input terminal for receiving the manipulation signal from the signal output terminal. The signal output terminal and the signal input terminal may be coupled together when the portable terminal is mounted on the terminal docking unit.

Accordingly, a manipulation signal from the display unit can be inputted to the terminal docking unit and then transferred to the portable terminal through the signal output terminal and the signal input terminal. Furthermore, the operation of the portable terminal can be controlled in response to the manipulation signal.

The display unit may include a power supply system for supplying a power source for an operation of the display unit. The portable terminal may be charged with the power source of the power supply system when the portable terminal is mounted on the terminal docking unit.

### BRIEF DESCRIPTION OF THE DRAWINGS

FIG. 1 is a front view showing a terminal device in accordance with an embodiment of the present invention.

FIG. 2 is a state diagram showing a process of attaching the portable terminal of FIG. 1.

FIG. 3 is a cross-sectional view showing major parts of the portable terminal and an attachment/detachment unit shown in FIG. 2.

FIG. 4 is a cross-sectional view showing a state in which the major parts shown in FIG. 3 are fully assembled.

FIG. 5 is a perspective view showing a process of mounting a portable terminal on a terminal device in accordance with another embodiment of the present invention.

FIGS. 6 and 7 are perspective views showing the first position and the second position of a terminal docking unit shown in FIG. 5.

FIG. 8 is a cross-sectional view showing major parts of the portable terminal and the terminal docking unit shown in FIG. 5.

### DESCRIPTION OF REFERENCE NUMERALS OF PRINCIPAL ELEMENTS IN THE DRAWINGS

100, 200: terminal device
110: portable terminal
112: terminal display unit
120: display unit
122: unit display unit
123, 223: attachment/detachment unit
210: terminal docking unit
212: insertion unit

### DETAILED DESCRIPTION OF THE INVENTION

Hereinafter, some exemplary embodiments of the present invention are described in detail with reference to the accompanying drawings. However, the present invention is not limited to or restricted by the embodiments. In the drawings, the same reference numerals are used to denote the same elements.

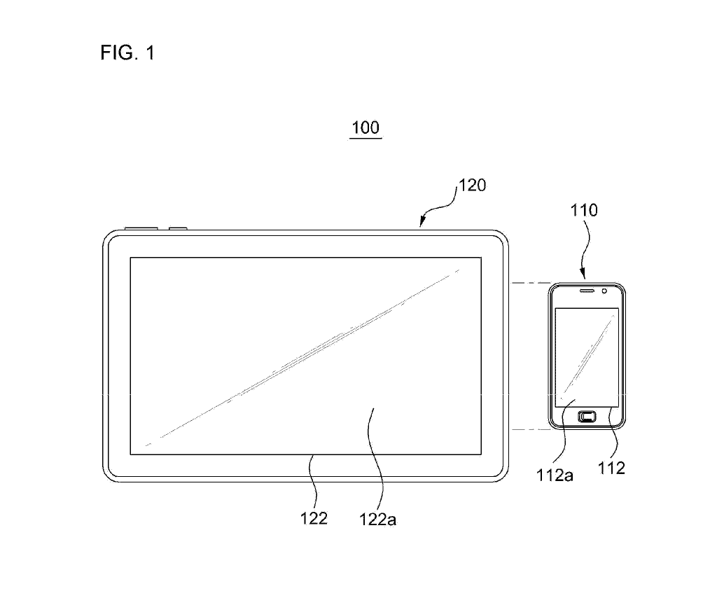

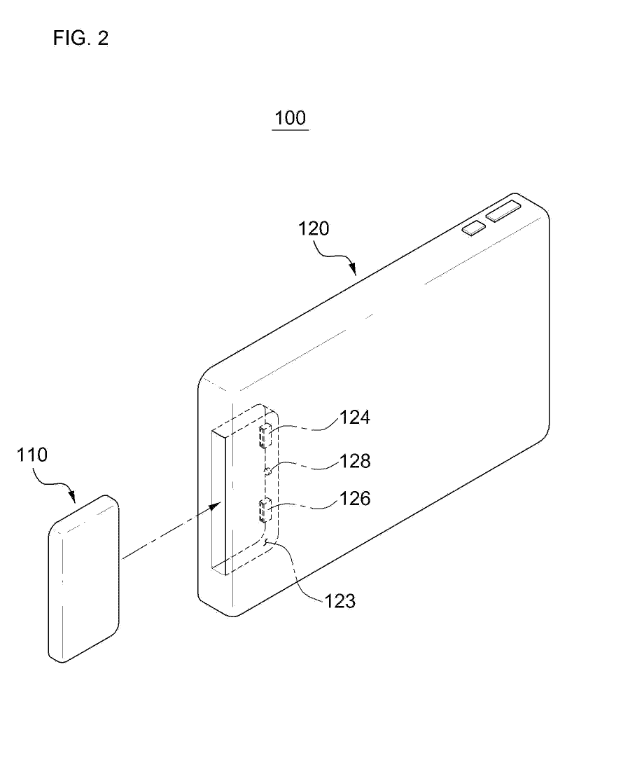

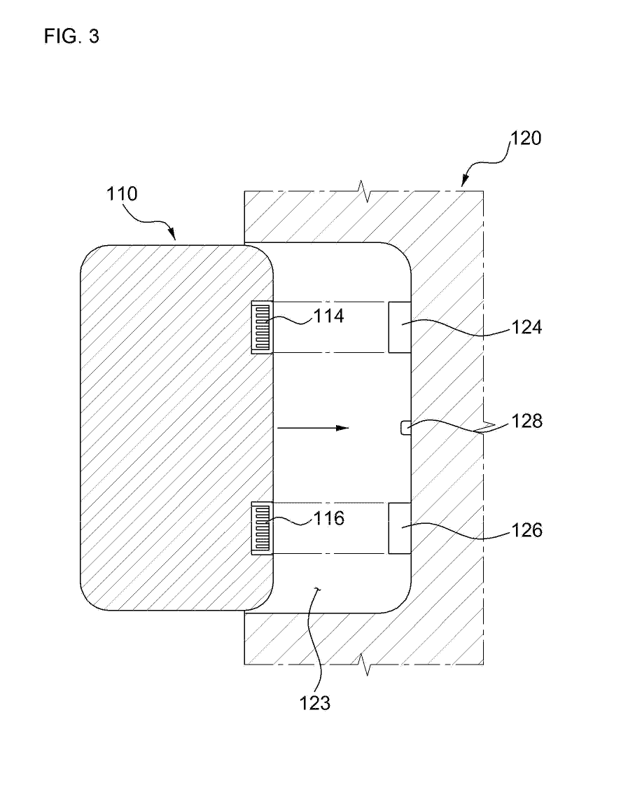

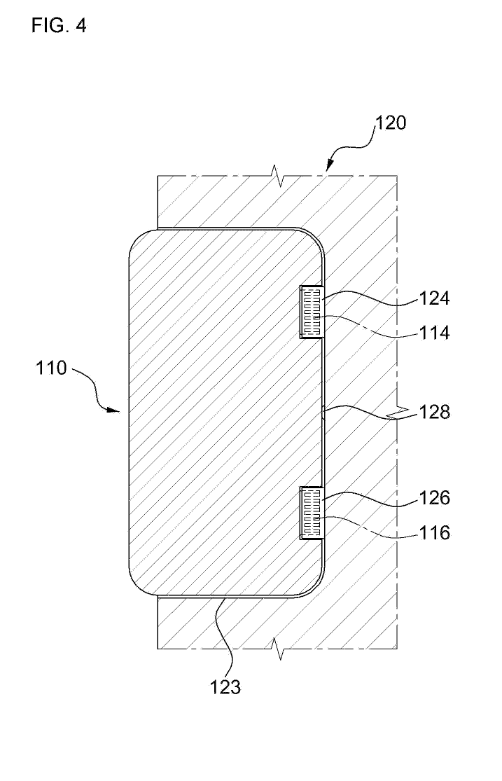

FIG. 1 is a front view showing a terminal device in accordance with an embodiment of the present invention, FIG. 2 is a state diagram showing a process of attaching the portable terminal of FIG. 1, FIG. 3 is a cross-sectional view showing major parts of the portable terminal and an attachment/detachment unit shown in FIG. 2, and FIG. 4 is a cross-sectional view showing a state in which the major parts shown in FIG. 3 are fully assembled.

Referring to FIGS. 1 to 4, the terminal device 100 in accordance with an embodiment of the present invention includes a portable terminal 110 and a display unit 120.

The portable terminal 110 can include all types of portable terminals for displaying a video externally. Here, the portable terminal means a terminal configured to have a small size and light weight so that the size, weight, and shape of the terminal do not give a burden on portability and to have an easy-carrying structure. Furthermore, the portable terminal 110 can include at least one of functions, such as a telephone call, Internet access, the play of a moving image and music, and the execution of various applications.

For example, the portable terminal 110 can include a smart phone, a Personal Digital Assistant (PDA), a common mobile phone, a portable game machine, a Portable Multimedia Player (MPM), and an MP3 player. It is hereinafter assumed that the portable terminal 110 is a smart phone.

Furthermore, a terminal display unit 112 for displaying various videos can be formed in the front of the portable terminal 110. The terminal display unit 112 has a limited screen size due to a limit to the size of the portable terminal 110. The terminal display unit 112 can include all types of displays capable of displaying a video, such as an LCD, an LED, and electronic ink. In the present invention, it is assumed that the terminal display unit 112 is an LCD.

The display unit 120 is a member for enlarging an image of the terminal display unit 112 formed in the portable terminal 110 and displaying the enlarged image. A unit display unit 122 configured to have a larger screen size than the terminal display unit 112 can be included in the front of the display unit 120. The unit display unit 122 can be formed in a maximum size in the front of the display unit 120. Likewise, the unit display unit 122 can include all types of displays, such as an LCD, an LED, and electronic ink. In the present embodiment, it is assumed that the unit display unit 122 is an LCD.

Furthermore, an attachment/detachment unit 123 to or from which the portable terminal 110 is attached or detached can be formed in the display unit 120. The attachment/detachment unit 123 can be formed in portions other than the front of the display unit 120. This is because if the attachment/detachment unit 123 is formed in the front of the display unit 120, the size of the unit display unit 122 formed in the front of the display unit 120 is reduced.

The attachment/detachment unit 123 can be configured in a groove shape into which the portable terminal 110 can be inserted on the side or in the rear of the display unit 120. A guide structure for guiding the attachment or detachment of the portable terminal 110 and a fastening structure for preventing the unintentional detachment of the portable terminal 110 can be formed within the attachment/detachment unit 123. In the present embodiment, the attachment/detachment unit 123 is illustrated as being formed on the side of the display unit 120 as shown in FIG. 2, and a description of the guide structure and the fastening structure is omitted.

Referring to FIGS. 2 to 4, a video output terminal 114 for outputting a video, displayed in the terminal display unit 112, in the form of a signal can be formed on the side of the portable terminal 110. A video input terminal 124 for receiving a video signal from the video output terminal 114 can be formed within the attachment/detachment unit 123. Each of the video output terminal 114 and the video input terminal 124 can be formed of a Universal Serial Bus (USB) terminal or a High Definition Multimedia Interface (HDMI) terminal, but is not limited thereto. For example, various types of terminals can be used as the video output terminal 114 and the video input terminal 124.

The video input terminal 124 and the video output terminal 114 can be directly coupled together when the portable terminal 110 is mounted on the attachment/detachment unit 123 or can be coupled together by an additional coupling member, such as a cable. In the present embodiment, it is assumed that the video input terminal 124 and the video output terminal 114 are coupled together when the portable terminal 110 is mounted on the attachment/detachment unit 123.

When the video input terminal 124 and the video output terminal 114 are coupled together as described above, a video of the terminal display unit 112 transferred through the video input terminal 124 and the video output terminal 114 can be displayed in the unit display unit 122.

Referring to FIGS. 2 to 4, a display unit power breaker for blocking power supplied to the terminal display unit 112 when the portable terminal 110 is mounted on the attachment/detachment unit 123 can be formed in the contact portion of the attachment/detachment unit 123 and the portable terminal 110. The display unit power breaker can be implemented to have a variety of structures in various ways.

For example, a press button for blocking power supplied to the terminal display unit 112 can be disposed in the contact portion of the portable terminal 110. A protrusion portion for pressing the press button when the portable terminal 110 is mounted on the attachment/detachment unit 123 can be formed within the attachment/detachment unit 123. In the present embodiment, it is assumed that a press button 128 for generating a power breaking signal for the terminal display unit 112 is protruded and formed within the attachment/detachment unit 123 and the power breaking signal is transferred to the portable terminal 110 through a signal input terminal 116 and a signal output terminal 126 when the press button 128 is pressed. That is, when the portable terminal 110 is fully mounted on the attachment/detachment unit 123, the press button 128 formed at a portion coming in contact with the portable terminal 110 is pressed and an operation signal generated from the press button 128 is transferred to the portable terminal 110, so a power source supplied to the terminal display unit 112 is blocked.

Meanwhile, the display unit 120 and the portable terminal 110 can be equipped with respective manipulation units 112a and 122a for receiving commands according to the manipulation of a user. Each of the manipulation units 112a and 122a can include at least one of a touch screen, a touch pad, a key pad, an electronic pen, a Joystick, and a keyboard.

In the present embodiment, it is assumed that the unit display unit 122 of the display unit 120 is equipped with a touch screen and the terminal display unit 112 of the portable terminal 110 is also equipped with a touch screen. Accordingly, text and numbers can be inputted through the touch screens of the display unit 120 and the portable terminal 110 by using a virtual keyboard program or a key pad interface program.

Referring to FIGS. 2 to 4, the signal output terminal 126 for outputting a manipulation of the manipulation unit 122a in the form of a signal can be formed in the display unit 120. The signal input terminal 116 for receiving the manipulation signal from the signal output terminal 126 can be formed in the portable terminal 110. Each of the signal output terminal 126 and the signal input terminal 116 can be formed of a Universal Serial Bus (USB) terminal, but is not limited thereto. For example, various types of terminals can be used as the signal output terminal 126 and the signal input terminal 116.

The signal output terminal 126 and the signal input terminal 116 can be directly coupled together when the portable terminal 110 is mounted on the attachment/detachment unit 123 or can be coupled together by an additional coupling member, such as a cable. In the present embodiment, it is assumed that the signal output terminal 126 and the signal input terminal 116 are coupled together when the portable terminal 110 is mounted on the attachment/detachment unit 123. Accordingly, the operation of the portable terminal 110 can be controlled in response to a manipulation signal received through the manipulation unit 122a of the display unit 120, that is, a touch screen.

Meanwhile, the display unit 120 can be equipped with a power supply system (not shown) and a cooling system (not shown). Here, the power supply system supplies a power source for the operation of the display unit 120. For example, the power supply system can include a chargeable battery, a common dry cell, or a power cable.

The display unit 120 can have a function of charging the portable terminal 110 mounted on the display unit 120 by using the power source of the power supply system. In the present invention, it is assumed that the power source of the display unit 120 is transferred to the portable terminal 110 through at least one of the video output terminal 114 and the video input terminal 124 and the signal output terminal 126 and the signal input terminal 116, but the present invention is not limited thereto. Additional charging terminals may be added to the portable terminal 110 and the display unit 120.

Furthermore, the cooling system cools the display unit 120. That is, the cooling system can stably maintain an environment in which the display unit 120 operates by preventing a temperature rise due to heat generated when the display unit 120 operates. The cooling system can also perform a function of cooling the portable terminal 110 mounted on the display unit 120. The cooling system for cooling the portable terminal 110 can be disposed near the attachment/detachment unit 123. For example, the cooling system can include a cooling fan or a heat-dissipation plate.

A process of mounting the portable terminal 110 on the attachment/detachment unit 123 of the terminal device 100 constructed as above in accordance with an embodiment of the present invention and advantages thereof are described below.

First, the portable terminal 110 is slidably inserted into the attachment/detachment unit 123 of the display unit 120. That is, the portable terminal 110 and the display unit 120 can be coupled together by only a simple operation of slidably inserting the portable terminal 110 into the attachment/detachment unit 123. In contrast, the portable terminal 110 and the display unit 120 can be separated from each other by only an operation of pulling out the portable terminal 110 from the attachment/detachment unit 123.

When the portable terminal 110 is inserted into the attachment/detachment unit 123 as described above, the video output terminal 114 of the portable terminal 110 can be coupled with the video input terminal 124 of the attachment/detachment unit 123, the signal input terminal 116 of the portable terminal 110 can be coupled with the signal output terminal 126 of the attachment/detachment unit 123, and the press button 128 of the attachment/detachment unit 123 can be pressed by the side of the portable terminal 110.

Accordingly, a video signal from the portable terminal 110 can be transferred to the display unit 120 through the video output terminal 114 and the video input terminal 124, and a video displayed in the terminal display unit 112 can be displayed in the unit display unit 122 of the display unit 120, having a larger screen, in response to the video signal. As a result, a user can conveniently use a variety of functions of the portable terminal 110 through the unit display unit 122 having a larger screen than the terminal display unit 112 of the portable terminal 110.

Furthermore, when a user inputs a variety of commands through the manipulation unit 122a of the display unit 120 in the state in which the portable terminal 110 and the display unit 120 are coupled together as described above, a manipulation signal inputted to the display unit 120 can be transferred to the portable terminal 110 through the signal output terminal 126 and the signal input terminal 116 and the operation of the portable terminal 110 can be controlled in response to the manipulation signal. Accordingly, a user can manipulate the operation of the portable terminal 110 through the display unit 120 without a need to directly manipulate the portable terminal 110.

Furthermore, when the press button 128 of the display unit power breaker is pressed by the portable terminal 110, a power breaking signal can be generated from the display unit power breaker. The power breaking signal can be transferred to the portable terminal 110 through the signal output terminal 126 and the signal input terminal 116. In response to the power breaking signal, the portable terminal 110 blocks a power source supplied to the terminal display unit 112, thereby being capable of reducing power consumption. When the portable terminal 110 is inserted into the attachment/detachment unit 123, the terminal display unit 112 of the portable terminal 110 does not need to be used because all pieces of information can be communicated and checked through the unit display unit 122 of the display unit 120.

If the display unit 120 does not need to be used, the portable terminal 110 may be detached from the attachment/detachment unit 123 of the display unit 120 and only the portable terminal 110 may be carried and used. That is, a user can selectively determine whether or not to use the display unit 120 depending on a use environment and his preference.

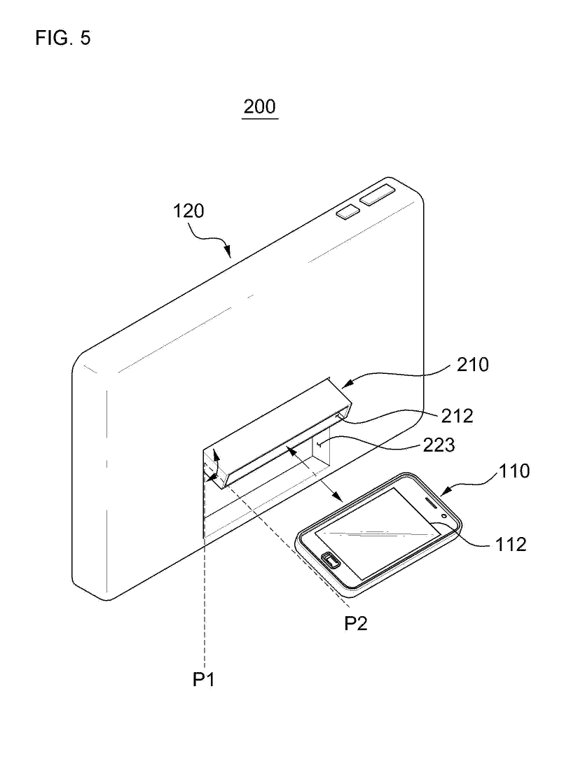

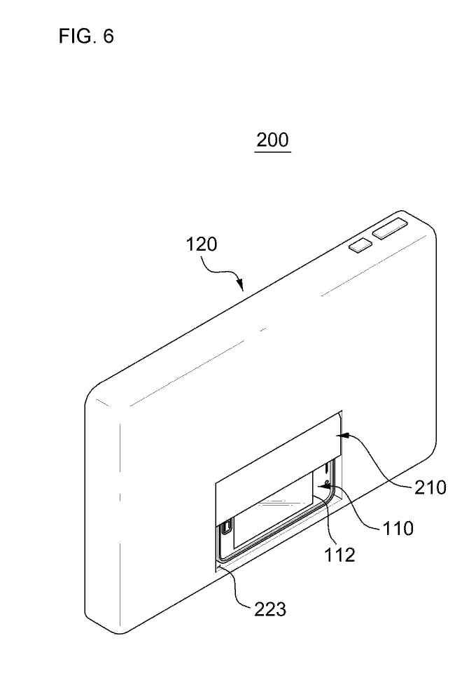

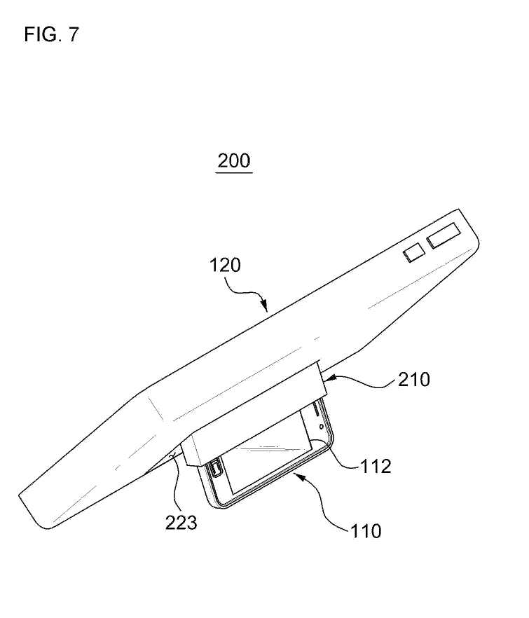

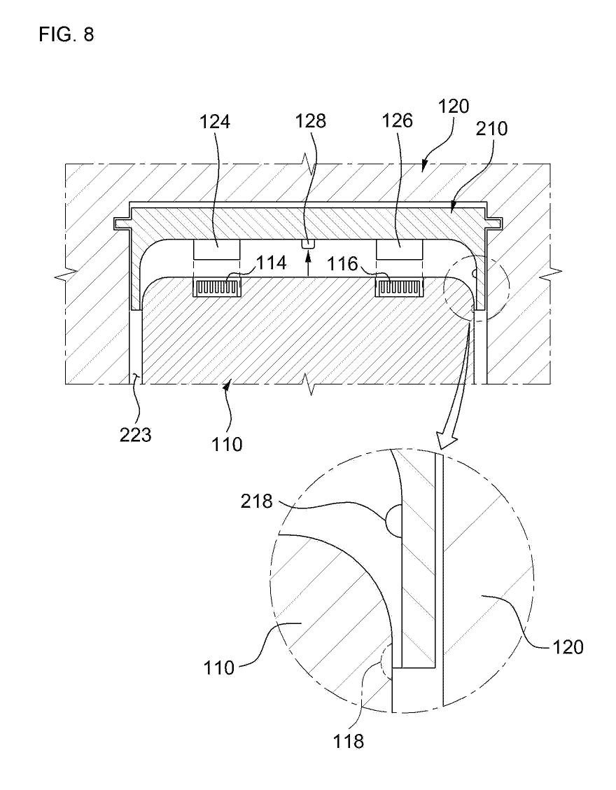

FIG. 5 is a perspective view showing a process of mounting a portable terminal on a terminal device in accordance with another embodiment of the present invention, and FIGS. 6 and 7 are perspective views showing the first position and the second position of a terminal docking unit shown in FIG. 5. Furthermore, FIG. 8 is a cross-sectional view showing major parts of the portable terminal and the terminal docking unit shown in FIG. 5.

In FIGS. 5 to 8, the same or similar parts as those of FIGS. 1 to 4 indicate the same elements. Only differences between the terminal device 200 in accordance with another embodiment of the present invention and the terminal device 100 of FIGS. 1 to 4 are chiefly described below.

Referring to FIGS. 5 to 8, the terminal device 200 in accordance with another embodiment of the present invention differs from the terminal device 100 of FIGS. 1 to 4 in that the portable terminal 110 is mounted on a terminal docking unit 210 provided in an attachment/detachment unit 223.

The terminal docking unit 210 is a member for relaying the transfer of signals between the portable terminal 110 and the display unit 120. Both side parts of the terminal docking unit 210 can be rotatably connected to the attachment/detachment unit 223 formed in the rear of the display unit 120. That is, both side parts of the terminal docking unit 210 can be rotatably hinged to both side parts of the inside of the attachment/detachment unit 223. The terminal docking unit 210 can be rotated around a hinge connection unit, but an angle in which the terminal docking unit 210 is rotated can be limited to an angle that defines a first position P1 and a second position P2.

Furthermore, an insertion unit 212 into which one side part of the portable terminal 110 is inserted can be formed in the terminal docking unit 210. The insertion unit 212 can be formed in the terminal docking unit 210 in a groove shape so that one side part of the portable terminal 110 can be slidably inserted into the terminal docking unit 210. Accordingly, the terminal docking unit 210 can be rotated along with the portable terminal 110 inserted into the insertion unit 212.

A latching groove 118 can be formed in one side part of the portable terminal 110. A latching protrusion 218 inserted into the latching groove 118 when the portable terminal 110 is mounted on the terminal docking unit 210 can be formed in one side part of the inside of the insertion unit 212 of the terminal docking unit 210. Whether the portable terminal 110 has been fully inserted into the insertion unit 212 or not can be checked and the unintentional detachment of the portable terminal 110 can also be prevented by the latching groove 118 and the latching protrusion 218.

Furthermore, the terminal docking unit 210 can be selectively disposed at either the first position P1 or the second position P2. At the first position P1, the portable terminal 110 and the terminal docking unit 210 are fully inserted into the attachment/detachment unit 223 as shown in FIG. 6. At the second position P2, the portable terminal 110 becomes apart from the display unit 120 at a specific angle so that the portable terminal 110 and the terminal docking unit 210 function as the support of the display unit 120 as shown in FIG. 7. That is, when the terminal docking unit 210 together with the portable terminal 110 is disposed at the second position P2, the display unit 120 is obliquely placed in a horizontal plane, such as a desk, at a specific angle. Accordingly, a user can view the unit display unit 122 in a comfortable posture more effectively.

Furthermore, the video input terminal 124, the signal output terminal 126, and the press button 128 of the display unit power breaker can be disposed in the insertion unit 212 of the terminal docking unit 210. When the portable terminal 110 is inserted into the insertion unit 212 as described above, the video output terminal 114 of the portable terminal 110 can be coupled with the video input terminal 124 of the terminal docking unit 210, the signal input terminal 116 of the portable terminal 110 can be coupled with the signal input terminal 116 of the terminal docking unit 210, and the press button 128 of the terminal docking unit 210 can be pressed by one side part of the portable terminal 110.

The video input terminal 124, the signal output terminal 126, and the press button 128 of the display unit power breaker in the present embodiment perform the same or similar functions as the video input terminal 124 and the signal output terminal 126 of the attachment/detachment unit 223 and the press button 128 of the display unit power breaker shown in FIGS. 3 and 4, and a detailed description thereof is omitted for simplicity.

Meanwhile, the terminal docking unit 210 can be coupled with the display unit 120 according to a variety of methods and structures so that signals can be exchanged. For example, a cable (not shown) for coupling the terminal docking unit 210 and the display unit 120 together can be disposed in such a way as to pass through the inside of the rotating axis of the hinge connection unit of the terminal docking unit 210 and the attachment/detachment unit 223, or a cable (not shown) for coupling the terminal docking unit 210 and the display unit 120 together can be connected to the attachment/detachment unit 223 through a portion in which the insertion unit 212 of the terminal docking unit 210 is not formed.

In the terminal device in accordance with an embodiment of the present invention, the portable terminal can be conveniently mounted on the display unit in a sliding way. Accordingly, the effectiveness of the terminal device can be improved because a user can use only the portable terminal or both the portable terminal and the display unit depending on a user environment.

Furthermore, the terminal device in accordance with an embodiment of the present invention can display a video, displayed in the terminal display unit of the portable terminal, in the unit display unit of the display unit. Accordingly, a user can conveniently use a variety of functions of the portable terminal in a screen wider than that of the terminal display unit of the portable terminal. As a result, the terminal device can remove inconvenience occurring because the terminal display unit has a small screen.

Furthermore, in the terminal device in accordance with an embodiment of the present invention, the portable terminal and the terminal docking unit can be rotated in the state in which the portable terminal has been coupled with the terminal docking unit and then used as the support of the display unit. Accordingly, the display unit can be disposed at an angle in which a user can use the terminal device conveniently by way of the terminal docking unit and the portable terminal.

Furthermore, in the terminal device in accordance with an embodiment of the present invention, when the portable terminal is coupled with the display unit, a power source supplied to the terminal display unit of the portable terminal is blocked. Accordingly, unnecessary power consumption due to the portable terminal can be reduced, and the operating time of the portable terminal can be increased.

Although the embodiments of the present invention have been described in connection with specific matters, such detailed elements, and the limited embodiments and drawings, they are provided only to help general understanding of the present invention, and the present invention is not limited to the embodiments. A person having ordinary skill in the art to which the present invention pertains may modify the present invention in various ways from the above description. Accordingly, the spirit of the present invention should not be construed as being limited to the embodiments, and not only the attached claims, but also all equivalent modifications thereof should be constructed as belonging to the category of the present invention.

What is claimed is:

1. A terminal device, comprising:
a portable terminal configured to have at least one function of a telephone call, Internet access, a play of a moving image and music, or an execution of various applications; and
a display unit couled with the portable terminal and configured to have a unit display unit formed in a front of the display unit, the unit display unit having a larger screen than the terminal display unit, enlarging a video displayed in a terminal display unit of the portable terminal, and displaying the enlarged video,
wherein an attachment/detachment unit to or from which the portable terminal is slidably attached or detached is formed in portions other than the front of the display unit so that signals are transferred to the portable terminal.

2. The terminal device of claim 1, wherein:
the portable terminal comprises a video output terminal for outputting the video displayed in the terminal display unit in a signal form,
the attachment/detachment unit comprises a video input terminal for displaying the video of the terminal display unit in the unit display unit in response to the video signal received from the video output terminal, and
the video input terminal and the video output terminal are coupled together when the portable terminal is mounted on the attachment/detachment unit.

3. The terminal device of claim 1, wherein a display unit power breaker for blocking a power source supplied to the terminal display unit when the portable terminal is mounted on the attachment/detachment unit is formed in a contact portion of the attachment/detachment unit and the portable terminal.

4. The terminal device of claim 1, wherein:
the display unit comprises a manipulation unit for receiving a command according to a manipulation of a user, and
the manipulation unit comprises at least one of a touch screen, a touch pad, a key pad, an electronic pen, a Joystick, and a keyboard.

5. The terminal device of claim 4, wherein:
the display unit comprises a signal output terminal for outputting the manipulation of the manipulation unit in a signal form,
the portable terminal comprises a signal input terminal for receiving the manipulation signal from the signal output terminal, and
the signal output terminal and the signal input terminal are coupled together when the portable terminal is mounted on the attachment/detachment unit.

6. The terminal device of claim 1, wherein:
the display unit comprises a power supply system for supplying a power source for an operation of the display unit, and
the portable terminal is charged with the power source of the power supply system when the portable terminal is mounted on the attachment/detachment unit.

7. A terminal device, comprising:
a portable terminal configured to have at least one function of a telephone call, Internet access, a play of a moving image and music, or an execution of various applications;
a display unit couled with the portable terminal and configured to have a unit display unit formed in a front of the display unit, the unit display unit having a larger screen than the terminal display unit, enlarging a video displayed in a terminal display unit of the portable terminal, and displaying the enlarged video; and
a terminal docking unit configured to have a first side rotatably coupled with an attachment/detachment unit formed in a rear of the display unit, have an insertion unit into which one side part of the portable terminal is inserted formed on a second side of the terminal docking unit, and relay signals between the portable terminal and the display unit,
wherein the terminal docking unit is selectively disposed at a first position where the portable terminal is inserted into the inside of the attachment/detachment unitor or a second position where the portable terminal becomes apart from the display unit at a specific angle so that the portable terminal and the terminal docking unit function as a support of the display unit.

8. The terminal device of claim 7, wherein:
both side parts of the terminal docking unit are rotatably hinged to both side parts of the attachment/detachment unit, and
the insertion unit is formed in a groove shape in the terminal docking unit so that one side part of the portable terminal is slidably inserted into the insertion unit.

9. The terminal device of claim 7, wherein:
the portable terminal comprises a video output terminal for outputting the video displayed in the terminal display unit in a signal form,
the terminal docking unit comprises a video input terminal for displaying the video of the terminal display unit in the unit display unit in response to the video signal received from the video output terminal, and
the video input terminal and the video output terminal are coupled together when the portable terminal is mounted on the terminal docking unit.

10. The terminal device of claim 7, wherein a display unit power breaker for blocking a power source supplied to the terminal display unit when the portable terminal is mounted on the terminal docking unit is formed in a contact portion of the terminal docking unit and the portable terminal.

11. The terminal device of claim 7, wherein:
the display unit comprises a manipulation unit for receiving a command according to a manipulation of a user, and
the manipulation unit comprises at least one of a touch screen, a touch pad, a key pad, an electronic pen, a Joystick, and a keyboard.

12. The terminal device of claim 11, wherein:
the terminal docking unit comprises a signal output terminal for outputting the manipulation of the manipulation unit in a signal form,
the portable terminal comprises a signal input terminal for receiving the manipulation signal from the signal output terminal, and
the signal output terminal and the signal input terminal are coupled together when the portable terminal is mounted on the terminal docking unit.

13. The terminal device of claim 7, wherein:
the display unit comprises a power supply system for supplying a power source for an operation of the display unit, and
the portable terminal is charged with the power source of the power supply system when the portable terminal is mounted on the terminal docking unit.
